(19) United States
(12) Patent Application Publication
(10) Pub. No.: US 2016/0326987 A1
(43) Pub. Date: Nov. 10, 2016

(54) THRUST VECTORING DEVICE

(71) Applicant: MITSUBISHI HEAVY INDUSTRIES, LTD., Tokyo (JP)

(72) Inventors: Atsushi MORIWAKI, Tokyo (JP); Shinsuke TAJIRI, Tokyo (JP); Fuminori FUJISAWA, Tokyo (JP); Daisuke HYUGA, Tokyo (JP)

(21) Appl. No.: 15/110,233

(22) PCT Filed: Feb. 17, 2015
(86) PCT No.: PCT/JP2015/054239

§ 371 Date: Jul. 7, 2016

(30) Foreign Application Priority Data
Feb. 19, 2014 (JP) 2014-029641

(51) Int. Cl. F02K 9/90

(52) U.S. Cl. CPC F02K 9/90

(57) ABSTRACT

A thrust vectoring device (101) equipped with: a shroud (102) having an opening; a nozzle (104) for spraying gas through the opening in the shroud (102), and provided in the interior of the shroud (102); a rotational drive shaft (140) positioned in parallel to the central axis (S104) of the shroud (102), and passing through one surface of the shroud (102); and a jet tab vectoring body (130) facing one surface of the shroud (102), and provided on one section of the rotational drive shaft (140) outside the shroud (102). Furthermore, a pressure adjustment part (110) is provided in the thrust vectoring device (101) so as to face the flow of the gas (151) directed toward the rotational drive shaft (140), and positioned on the one surface of the shroud (102) and/or the surface of the jet tab vectoring body (130) facing the one surface of the shroud (102).

### TECHNICAL FIELD

The present invention relates to a thrust vectoring device which performs control during flight of a flying object.

Priority is claimed on Japanese Patent Application No.2014-029641, filed Feb. 19, 2014, the content of which is incorporated herein by reference.

### BACKGROUND ART

In a flying object, in order to perform posture control and control of a flight direction of the flying object, a thrust vectoring device which changes the direction of thrust by controlling a jet direction of high-temperature gas which is jetted from a propulsion engine, and generates motion required for control in the flying object, is provided.

As an example of such a thrust vectoring device, a thrust vectoring device in which a member called a jet tab vectoring body which interferes with jet of high-temperature gas is disposed in the vicinity of an outlet of a nozzle which jets the high-temperature gas is shown in FIGS. 14 to 16. FIG. 14 schematically shows a perspective view of a thrust vectoring device of the related art, FIG. 15 schematically shows a plan view of the thrust vectoring device disposed at an open end of a flying object, and FIG. 16 schematically shows a sectional view of the thrust vectoring device taken along line K-K of FIG. 15.

As shown in FIGS. 14 to 16, the thrust vectoring device has a tubular shroud 7, a tubular nozzle 4 which is provided to have an axis concentric with that of the shroud 7 in the interior of the shroud 7 and jets high-temperature gas, a flat plate-shaped flange 3 which configures one surface of the shroud 7 and surrounds the nozzle 4, columnar rotational drive shafts 71 to 74 provided to penetrate the flange 3 between the nozzle 4 and the shroud 7, and flat plate-shaped jet tab vectoring bodies 11 to 14 respectively mounted on the rotational drive shafts 71 to 74 so as to face the flange 3.

Each of the jet tab vectoring bodies 11 to 14 is rotated by each of the rotational drive shafts 71 to 74, whereby the tip thereof can be moved to the upper side of the nozzle 4. In FIG. 15, a state where the jet tab vectoring body 13 has been moved to the upper side of the nozzle 4 is shown. In this manner, if each of the jet tab vectoring bodies 11 to 14 is moved to the upper side of the nozzle 4, the high-temperature gas which is jetted from the nozzle 4 collides with the jet tab vectoring body, whereby the jet direction thereof is changed. If the movement amount of the jet tab vectoring body is controlled according to a desired jet direction, the direction of the thrust acting on the flying object is changed, and thus the posture control and the control of a flight direction of the flying object are realized (for example, PTL 1).

However, in the thrust vectoring device having the jet tab vectoring body configured in this manner, if the jet tab vectoring body is moved onto the nozzle for thrust vectoring, the jet tab vectoring body is exposed to very high-temperature gas which can reach 2000° C. As shown in FIG. 16, the high-temperature gas which has collided with the jet tab vectoring body 13 infiltrates into the gap between the jet tab vectoring body 13 and the flange 3 while maintaining a high temperature, as shown by an arrow 51, and reaches the rotational drive shaft 73. For this reason, the thrust vectoring device has a problem in which the rotational drive shaft 73 is heated to a high temperature by the high-temperature gas and a bearing or a drive unit for controlling the jet tab vectoring body 13 by rotating the rotational drive shaft 73 is damaged.

### CITATION LIST

### Patent Literature

[PTL 1] U.S. Pat. No. 4,274,610

### SUMMARY OF INVENTION

### Technical Problem

Therefore, in the present invention, a bearing or a drive unit of a rotational drive shaft is prevented from being damaged due to a flow of high-temperature gas reaching the rotational drive shaft through a gap between a jet tab vectoring body and a flange at the time of thrust vectoring.

### Solution to Problem

In order to solve the above problem, according to a first aspect of the present invention, there is provided a thrust vectoring device including: a shroud having an opening; a nozzle which is disposed inside of the shroud and jets gas through the opening of the shroud; a rotational drive shaft disposed parallel to a central axis of the shroud to penetrate one surface of the shroud; and a jet direction vectoring member which is provided at a portion of the rotational drive shaft which is located outside the shroud, and faces the one surface of the shroud, wherein a pressure adjustment part disposed to face a flow of gas which heads for the rotational drive shaft is provided on at least one surface of the one surface of the shroud and a surface facing the one surface of the shroud, of the jet direction vectoring member.

In the thrust vectoring device configured in this manner, gaps having different distances are formed between the one surface of the shroud and the jet direction vectoring member by the pressure adjustment part disposed to face the flow of the gas which heads for the rotational drive shaft, and thus a portion having a rapidly reduced cross-sectional area and a portion having a rapidly enlarged cross-sectional area are formed. For this reason, when the gas flows into the portion having a rapidly enlarged cross-sectional area, a pressure loss is generated, and thus flow path resistance increases. Thereby, infiltration of the high-temperature gas into the gap between the one surface of the shroud and the jet direction vectoring member is suppressed. Therefore, heating of the rotational drive shaft by the high-temperature gas which has infiltrated into the gap between the one surface of the shroud and the jet direction vectoring member is prevented, and damage to a bearing or a drive unit for driving the rotational drive shaft is prevented.

Further, in a thrust vectoring device according to a second aspect of the present invention, each of the one surface of the shroud and the jet direction vectoring member in the first aspect may have a flat plate shape, and the one surface of the shroud and a facing surface of the jet direction vectoring member may be parallel to each other.

In the thrust vectoring device configured in this manner, gaps having different distances are formed between the one surface of the shroud and the facing parallel surface of the jet direction vectoring member by the pressure adjustment part, and a pressure loss is generated by a portion in which a cross-sectional area is rapidly enlarged, and thus flow path resistance increases. Thereby, infiltration of the high-temperature gas into the gap between the one surface of the shroud and the jet direction vectoring member is suppressed. Therefore, heating of the rotational drive shaft by the high-temperature gas is prevented, and damage to the bearing or the drive unit for driving the rotational drive shaft is prevented.

Further, in a thrust vectoring device according to a third aspect of the present invention, the pressure adjustment part in the first or second aspect may be a protrusion portion which protrudes in a vertical direction from at least one surface of the one surface of the shroud and a facing surface of the jet direction vectoring member.

In the thrust vectoring device configured in this manner, gaps having different distances are formed between the one surface of the shroud and the jet direction vectoring member by the pressure adjustment part which is a protrusion portion protruding in the vertical direction, and a pressure loss is generated by a portion in which a cross-sectional area is rapidly enlarged, and thus flow path resistance increases. Thereby, infiltration of the high-temperature gas into the gap between the one surface of the shroud and the jet direction vectoring member is suppressed. Therefore, heating of the rotational drive shaft by the high-temperature gas is prevented, and damage to the bearing or the drive unit for driving the rotational drive shaft is prevented. Further, due to the projecting protrusion portion, the high-temperature gas which has collided with the jet direction vectoring member is prevented from linearly heading for the rotational drive shaft.

Further, in a thrust vectoring device according to a fourth aspect of the present invention, the pressure adjustment part in the first or second aspect may be a recess portion provided in at least one surface of the one surface of the shroud and a facing surface of the jet direction vectoring member.

In the thrust vectoring device configured in this manner, gaps having different distances are formed between the one surface of the shroud and the jet direction vectoring member by the pressure adjustment part which is a recess portion, and a pressure loss is generated by a portion in which a cross-sectional area is rapidly enlarged, and thus flow path resistance increases. Thereby, infiltration of the high-temperature gas into the gap between the one surface of the shroud and the jet direction vectoring member is suppressed. Therefore, heating of the rotational drive shaft by the high-temperature gas is prevented, and damage to the bearing or the drive unit for driving the rotational drive shaft is prevented. Further, recess portions are provided in one surface of the existing shroud and the jet direction vectoring member without requiring an additional member, and therefore, a reduction in the weight of the thrust vectoring device is attained.

Further, in a thrust vectoring device according to a fifth aspect of the present invention, the pressure adjustment parts in any one of the first to fourth aspects may be provided on the one surface of the shroud and a surface of the jet direction vectoring member, and the pressure adjustment part provided on the surface of the jet direction vectoring member may be disposed closer to the nozzle than the pressure adjustment part provided on the one surface of the shroud.

In the thrust vectoring device configured in this manner, first, by the pressure adjustment part provided on the surface of the jet direction vectoring member, which is disposed closer to the nozzle, the high-temperature gas flowing along the surface of the jet direction vectoring member is prevented from directly reaching the rotational drive shaft, and subsequently, by the pressure adjustment part provided on the one surface of the shroud, large flow path resistance is generated with respect to the high-temperature gas going around the outside of the pressure adjustment part provided on the surface of the jet direction vectoring member.

Further, in a thrust vectoring device according to a sixth aspect of the present invention, gaps having different distances, provided between the one surface of the shroud and the jet direction vectoring member in any one of the first to fifth aspects, may become smaller in order as it goes toward the outside from a central axis of the nozzle.

In the thrust vectoring device configured in this manner, the distance of the gap which is formed by the pressure adjustment part closest to the nozzle and reaching the highest temperature is large, and therefore, the distance between each pressure adjustment part and the jet direction vectoring member or the one surface of the shroud when the pressure adjustment parts have thermally expanded can be made to be very small and constant.

Further, in a thrust vectoring device according to a seventh aspect of the present invention, the pressure adjustment part in any one of the first to sixth aspects may be provided so as to surround the rotational drive shaft.

In the thrust vectoring device configured in this manner, the high-temperature gas can be more effectively prevented from reaching the rotational drive shaft, and the pressure adjustment part is reduced in size, and thus a reduction in the weight of the thrust vectoring device is attained.

Further, in a thrust vectoring device according to an eighth aspect of the present invention, the pressure adjustment part in the first or second aspect may be a protrusion portion which protrudes from a surface of the jet direction vectoring member, and when the jet direction vectoring member in a non-vectoring operation state is disposed orthogonal to a plane which includes a central axis of the nozzle and a rotation axis of the rotational drive shaft, a length from the surface of the jet direction vectoring member in a surface facing the central axis side of the nozzle, of the protrusion portion, may be shorter than a length from the surface of the jet direction vectoring member in a surface facing the side opposite to the surface facing the central axis side, of the protrusion portion.

In the thrust vectoring device configured in this manner, even in a case where the pressure adjustment part is unevenly heated and thermally expands, the distance between the pressure adjustment part which has thermally expanded and the jet direction vectoring member or the one surface of the shroud can be made to be very small and constant.

Further, in a thrust vectoring device according to a ninth aspect of the present invention, the one surface of the shroud in the first aspect may have a radially inner surface in which the opening is formed, and a radially outer surface through which the rotational drive shaft penetrates and which is provided at a position farther away from the jet direction vectoring member than the radially inner surface, and the pressure adjustment part may be a stepped portion in the shroud, which connects the radially inner surface and the radially outer surface and forms a stepped surface along an extending direction of the rotational drive shaft between the radially inner surface and the radially outer surface.

When the gas jetted from the nozzle passes between the one surface of the shroud and the jet direction vectoring member, first, the gas flows along the radially inner surface on the side closer to the jet direction vectoring member. Here, the stepped portion as the pressure adjustment part is formed, whereby the cross-sectional area of a flow path of the gas is rapidly enlarged at the position of the radially outer surface, and thus a pressure loss is generated and flow path resistance increases, whereby damage to the bearing or the drive unit for driving the rotational drive shaft can be prevented. Further, the gas flowing along the radially inner surface flows toward the outside in the radial direction of the nozzle as it is, and therefore, the gas flows at a position away from the radially outer surface. Accordingly, the gas flows through a position away from the bearing or the drive unit for driving the rotational drive shaft, and thus it is possible to prevent damage to the bearing or the drive unit.

Further, in a thrust vectoring device according to a tenth aspect of the present invention, the pressure adjustment part in any one of the first to ninth aspects may be a protrusion portion which protrudes in a vertical direction from a facing surface of the jet direction vectoring member, the nozzle may have a projecting portion which projects from the shroud, and the thrust vectoring device may further include a rib portion which protrudes from at least one of a surface facing the outside in a radial direction of the nozzle in the projecting portion and the protrusion portion toward the other.

By providing the rib portion in this manner, it is possible to further reduce the gap between the pressure adjustment part and the nozzle and it is possible to change a flow direction of the gas. For this reason, a pressure loss increases, and thus it becomes difficult for the gas to pass between the one surface of the shroud and the jet direction vectoring member. Therefore, it is possible to prevent damage to the bearing or the drive unit for driving the rotational drive shaft due to the gas.

Further, in a thrust vectoring device according to an eleventh aspect of the present invention, the rotational drive shaft in any one of the first to tenth aspects may be disposed at a position where a central axis of the rotational drive shaft and a center line in a width direction along a circumferential direction of the nozzle in the jet direction vectoring member do not intersect one another in a state where the jet direction vectoring member is disposed inside of the nozzle.

The gas flowing along the surface facing the one surface of the shroud in the jet direction vectoring member flows along an extending direction of the center line of the jet direction vectoring member. Therefore, by providing the rotational drive shaft such that a state where the central axis of the rotational drive shaft is shifted in position from the center line of the jet direction vectoring member is created, it is possible to prevent the gas from flowing toward the rotational drive shaft. As a result, it is possible to prevent damage to the bearing or the drive unit for driving the rotational drive shaft due to the gas.

Further, in a thrust vectoring device according to a twelfth aspect of the present invention, the jet direction vectoring member in the eleventh aspect may have a base end portion in which the rotational drive shaft is provided, and a tip portion which extends to be bent or curved from the base end portion.

The gas flowing along the surface facing the one surface of the shroud in the jet direction vectoring member flows along an extending direction of the tip portion. The tip portion is provided to be bent or curved with respect to the base end portion, and therefore, the base end portion extends in a direction different from the extending direction of the tip portion. Therefore, it is possible to prevent the gas from flowing toward the rotational drive shaft provide at the base end portion, and thus it is possible to prevent damage to the bearing or the drive unit for driving the rotational drive shaft due to the gas.

According to a thirteenth aspect of the present invention, there is provided a thrust vectoring device including: a shroud having an opening; a nozzle which is disposed inside of the shroud and jets gas through the opening of the shroud; a rotational drive shaft disposed parallel to a central axis of the shroud to penetrate one surface of the shroud; and a jet direction vectoring member which is provided at a portion of the rotational drive shaft which is located outside the shroud, and faces the one surface of the shroud, wherein the rotational drive shaft is disposed at a position where a central axis of the rotational drive shaft and a center line in a width direction along a circumferential direction of the nozzle in the jet direction vectoring member do not intersect one another in a state where the jet direction vectoring member is disposed inside of the nozzle.

In this manner, by providing the rotational drive shaft such that a state where the central axis of the rotational drive shaft is shifted in position from the center line of the jet direction vectoring member is created, the gas can be prevented from flowing toward the rotational drive shaft. As a result, it is possible to prevent damage to the bearing or the drive unit for driving the rotational drive shaft due to the gas.

### Advantageous Effects of Invention

In the thrust vectoring device described above, gaps having different distances are formed between the one surface of the shroud and the jet direction vectoring member by the pressure adjustment part, and thus a portion having a rapidly reduced cross-sectional area and a portion having a rapidly enlarged cross-sectional area are formed. For this reason, when the gas flows into the portion having a rapidly enlarged cross-sectional area, a pressure loss is generated, and thus flow path resistance increases. Thereby, infiltration of the high-temperature gas into the gap between the one surface of the shroud and the jet direction vectoring member is suppressed. Therefore, heating of the rotational drive shaft due to the high-temperature gas which has infiltrated into the distance between the one surface of the shroud and the jet direction vectoring member reaching the rotational drive shaft is prevented, and damage to the bearing or the drive unit for driving the rotational drive shaft is prevented.

### BRIEF DESCRIPTION OF DRAWINGS

FIG. 1A is a simplified plan view showing a first embodiment of a thrust vectoring device according to the present invention.

FIG. 1B is a simplified sectional view showing the first embodiment of the thrust vectoring device according to the present invention.

FIG. 2A is a simplified plan view showing a second embodiment of the thrust vectoring device according to the present invention.

FIG. 2B is a simplified sectional view showing the second embodiment of the thrust vectoring device according to the present invention.

FIG. 3A is a simplified plan view showing a third embodiment of the thrust vectoring device according to the present invention.

FIG. 3B is a simplified sectional view showing the third embodiment of the thrust vectoring device according to the present invention.

FIG. 4A is a simplified plan view showing a fourth embodiment of the thrust vectoring device according to the present invention.

FIG. 4B is a simplified sectional view showing the fourth embodiment of the thrust vectoring device according to the present invention.

FIG. 5A is a simplified plan view showing a fifth embodiment of the thrust vectoring device according to the present invention.

FIG. 5B is a simplified sectional view showing the fifth embodiment of the thrust vectoring device according to the present invention.

FIG. 6A is a simplified plan view showing a sixth embodiment of the thrust vectoring device according to the present invention.

FIG. 6B is a simplified sectional view showing the sixth embodiment of the thrust vectoring device according to the present invention.

FIG. 7A is a simplified plan view showing a seventh embodiment of the thrust vectoring device according to the present invention.

FIG. 7B is a simplified sectional view showing the seventh embodiment of the thrust vectoring device according to the present invention.

FIG. 8A is a simplified plan view showing an eighth embodiment of the thrust vectoring device according to the present invention.

FIG. 8B is a simplified sectional view showing the eighth embodiment of the thrust vectoring device according to the present invention.

FIG. 9A is a simplified plan view showing a ninth embodiment of the thrust vectoring device according to the present invention.

FIG. 9B is a simplified sectional view showing the ninth embodiment of the thrust vectoring device according to the present invention.

FIG. 10A is a simplified plan view showing a tenth embodiment of the thrust vectoring device according to the present invention.

FIG. 10B is a simplified sectional view showing the tenth embodiment of the thrust vectoring device according to the present invention.

FIG. 11 is a simplified sectional view showing a modification example of the tenth embodiment of the thrust vectoring device according to the present invention.

FIG. 12A is a simplified plan view showing an eleventh embodiment of the thrust vectoring device according to the present invention.

FIG. 12B is a simplified sectional view showing the eleventh embodiment of the thrust vectoring device according to the present invention.

FIG. 13 is a simplified plan view showing a modification example of the eleventh embodiment of the thrust vectoring device according to the present invention.

FIG. 14 is a perspective view showing a thrust vectoring device of the related art.

FIG. 15 is a plan view showing the thrust vectoring device of the related art.

FIG. 16 is a sectional view showing the thrust vectoring device of the related art.

### DESCRIPTION OF EMBODIMENTS

Hereinafter, embodiments of the present invention will be described in detail with reference to the accompanying drawings. In addition, in the accompanying drawings, the same constituent elements are denoted by the same reference numerals.

### First Embodiment

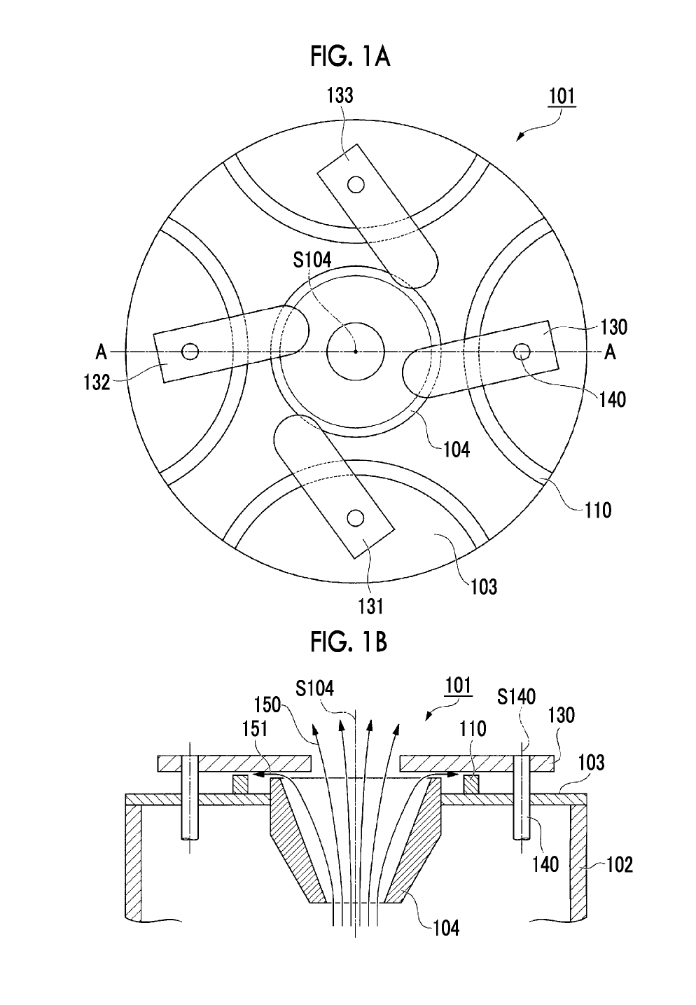

FIG. 1A is a schematic plan view showing a thrust vectoring device 101 of a first embodiment of the present invention, and FIG. 1B is a schematic sectional view taken along line A-A of the thrust vectoring device 101 shown in FIG. 1A.

The thrust vectoring device 101 of the first embodiment of the present invention is mounted on a rear end of a flying object (not shown). The thrust vectoring device 101 is provided with a tubular shroud 102, a tubular nozzle 104 disposed such that a central axis thereof coincides with a central axis S104 of the shroud 102, a flat plate-shaped flange 103 which configures one surface of the shroud 102 and surrounds the nozzle 104, a plurality of columnar rotational drive shafts 140 provided parallel to the central axis of the shroud 102 to penetrate the flange 103 between the nozzle 104 and the shroud 102, and flat plate-shaped jet tab vectoring bodies 130 to 133 each mounted on each of the rotational drive shafts 140 so as to face the flange 103 with a predetermined distance therebetween and capable of rotating about a central axis S140 of the rotational drive shaft 140. The surfaces facing the one surface of the shroud 102 in the jet tab vectoring bodies 130 to 133 are made to be parallel to the one surface of the shroud 102. Four rotational drive shafts 140 are disposed equidistantly in a circumferential direction of the nozzle 104 on two mutually orthogonal lines passing through the central axis S104 of the nozzle 104. The respective rotational drive shafts 140 can be independently controlled. Further, on the surface of the flange 103, which faces the jet tab vectoring body 130, a pressure adjustment part 110 is provided so as to protrude from the /flange 103. The gap between the pressure adjustment part 110 and the jet tab vectoring body 130 has a narrower distance than the gap between the flange 103 at which the pressure adjustment part 110 is not provided and the jet tab vectoring body 130.

At the time of flight of the flying object with the thrust vectoring device 101 mounted thereon, the nozzle 104 jets high-temperature gas, as shown by an arrow 150, thereby generating thrust. If the jet tab vectoring body 130 is rotated about the central axis S140 of the rotational drive shaft 140, whereby the tip thereof is moved to the upper side of the nozzle 104, a part of the high-temperature gas which is jetted from the nozzle 104 collides with the portion moved to the upper side of the nozzle 104, of the jet tab vectoring body 130. The jet tab vectoring body 130 can be rotated at a desired angle of rotation about the central axis S140 of the rotational drive shaft 140. For this reason, the amount of collision of the high-temperature gas with the jet tab vectoring body 130 is changed by controlling the movement amount of the tip of the jet tab vectoring body 130 to the upper side of the nozzle 104. The high-temperature gas which has collided with the jet tab vectoring body 130 changes in jet direction thereof, and therefore, the posture or the flight direction of the frying object with the thrust vectoring device 101 mounted thereon is controlled by vectoring the jet direction of the high-temperature gas by a predetermined amount by controlling the movement amount of the tip of the jet tab vectoring body 130 to the upper side of the nozzle 104.

Some gas of the high-temperature gas which has collided with the jet tab vectoring body 130 infiltrates into the gap between the jet tab vectoring body 130 and the flange 103. The high-temperature gas which has infiltrated flows through the gap between the jet tab vectoring body 130 and the flange 103 in a direction away from the nozzle 104 along the jet tab vectoring body 130, as shown by an arrow 151.

The pressure adjustment part 110 having a convex cross-sectional shape is provided on the surface of the flange 103. For this reason, a flow path which is formed between the jet tab vectoring body 130 and the flange 103 has a portion in which a cross-sectional area changes rapidly. Specifically, the gap between the jet tab vectoring body 130 and the flange 103, through which the high-temperature gas passes, first has a portion having a wide cross-sectional area, at which the pressure adjustment part 110 is not provided. Subsequently, the cross-sectional area of the gap is rapidly reduced due to the pressure adjustment part 110. Further, the cross-sectional area of the gap is rapidly enlarged in a portion at which the pressure adjustment part 110 is not provided.

Rapid enlargement of the cross-sectional area of a flow path causes a pressure loss, and for this reason, flow path resistance increases. In the first embodiment of the present invention, in a gap which is formed between the jet tab vectoring body 130 and the flange 103 disposed to face each other, the cross-sectional area thereof is rapidly reduced at a portion at which the pressure adjustment part 110 is provided, and subsequently, the cross-sectional area is rapidly enlarged at a portion at which the pressure adjustment part 110 is not provided. For this reason, flow path resistance due to a pressure loss increases. The high-temperature gas which flows in a direction away from the nozzle 104 along the jet tab vectoring body 130 through the gap which is formed between the jet tab vectoring body 130 and the flange 103 receives large flow path resistance in the portion in which a cross-sectional area is rapidly enlarged. For this reason, the high-temperature gas is prevented from reaching the rotational drive shaft 140, and as a result, damage to the rotational drive shaft 140 and a bearing or a drive unit (not shown) for driving the rotational drive shaft 140 due to a temperature rise is prevented.

The pressure adjustment part 110 may be formed integrally with the flange 103, and otherwise, a separate member may be mounted as the pressure adjustment part 110.

In FIG. 1A, the pressure adjustment part 110 which has a planar shape that is an arc shape convex toward the nozzle 104 and in which both ends are provided to extend to the outer edge of the flange 103 is shown. However, the shape of the pressure adjustment part 110 is not limited thereto and may be, for example, a linear planar shape or a planar shape that is an arc shape concave toward the nozzle 104. Further, a zigzag line shape or other curved line shapes are also acceptable. Further, in FIG. 1A, the pressure adjustment part 110 with both ends provided to extend to the outer edge of the flange 103 is shown. However, both ends may not be provided to extend to the outer edge of the flange 103. In this case, the pressure adjustment part 110 is reduced in size, and therefore, it is possible to realize a reduction in the weight of the device. However, in order to reliably prevent the high-temperature gas from reaching the rotational drive shaft 140, it is desirable that the pressure adjustment part 110 is provided to extend over at least a rotationally movable range of the jet tab vectoring body 130. Further, in FIG. 1B, the pressure adjustment part 110 is shown as a flat plate shape having a thickness smaller than a height. However, the cross-sectional shape of the pressure adjustment part 110 may be a block shape having a relatively large thickness. In a case where the pressure adjustment part 110 has a flat plate shape, it is possible to realize a reduction in the weight of the device. In a case where the pressure adjustment part 110 has a block shape, the pressure adjustment part 110 has the advantage of having rigidity capable of withstanding the collision of the high-temperature gas.

It is preferable that the nozzle 104, the flange 103, the jet tab vectoring body 130, and the pressure adjustment part 110 are made of a material having heat resistance and strength which can withstand the collision of the high-temperature gas which can reach 2000° C.

### Second Embodiment

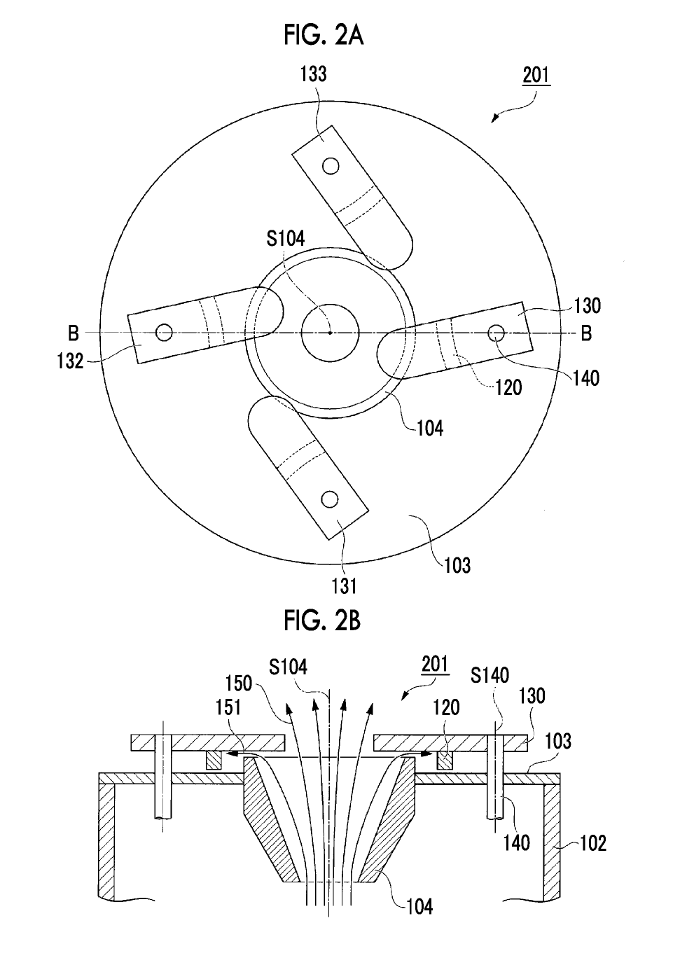

FIG. 2A is a schematic plan view showing a thrust vectoring device 201 of a second embodiment of the present invention, and FIG. 2B is a schematic sectional view taken along line B-B of the thrust vectoring device 201 shown in FIG. 2A.

The second embodiment is characterized in that instead of the pressure adjustment part 110 provided on the upper side of the flange 103 in the first embodiment, a pressure adjustment part 120 is provided on the jet tab vectoring body 130.

The pressure adjustment part 120 forms a portion in which a cross-sectional area is rapidly reduced and a portion in which a cross-sectional area is rapidly enlarged, in the gap between the jet tab vectoring body 130 and flange 103, and therefore, similar to the pressure adjustment part 110 in the first embodiment, large flow path resistance is generated with respect to gas flowing through the gap between the jet tab vectoring body 130 and flange 103 due to a pressure loss in the portion in which a cross-sectional area is rapidly enlarged.

If the tip of the jet tab vectoring body 130 is moved to the upper side of the nozzle 104 for thrust vectoring, the high-temperature gas infiltrates into the gap between the jet tab vectoring body 130 and the flange 103 along the surface of the jet tab vectoring body 130. Therefore, the pressure adjustment part 120 provided at the jet tab vectoring body 130 generates larger flow path resistance with respect to the high-temperature gas which infiltrates along the surface of the jet tab vectoring body 130, thereby preventing the high-temperature gas from directly reaching the rotational drive shaft 140.

The pressure adjustment part 120 may be formed integrally with the jet tab vectoring body 130, and otherwise, a separate member may be mounted as the pressure adjustment part 120.

In FIG. 2A, the pressure adjustment part 120 having a planar shape that is an arc shape convex toward the nozzle 104 is shown. However, the shape of the pressure adjustment part 120 is not limited thereto and may be, for example, a linear planar shape or a planar shape that is an arc shape concave toward the nozzle 104. Further, a zigzag line shape or other curved line shapes are also acceptable. Further, in FIG. 2A, the pressure adjustment part 110 with both ends provided to extend to the outer edges of the jet tab vectoring body 130 is shown. However, both ends may not be provided to extend to the outer edges of the jet tab vectoring body 130.

### Third Embodiment

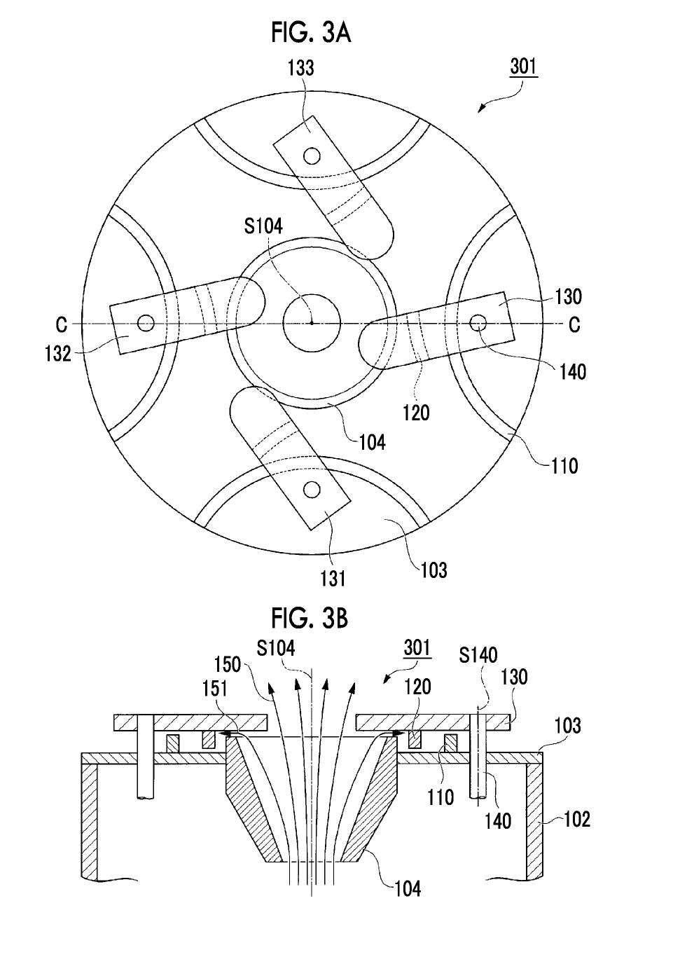

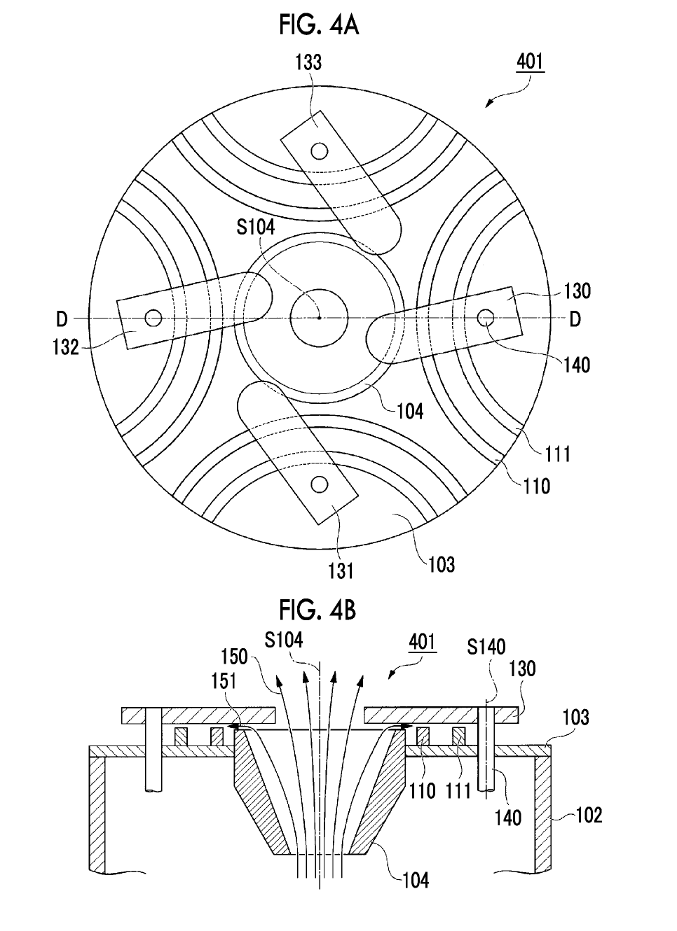

FIG. 3A is a schematic plan view showing a thrust vectoring device 301 of a third embodiment of the present invention, and FIG. 3B is a schematic sectional view taken along line C-C of the thrust vectoring device 301 shown in FIG. 3A.

The thrust vectoring device 301 of the third embodiment is characterized in that the pressure adjustment part 110 is provided on the flange 103 and the pressure adjustment part 120 is also provided on the jet tab vectoring body 130.

The pressure adjustment parts 110 and 120 form a portion in which a cross-sectional area is rapidly reduced and a portion in which a cross-sectional area is rapidly enlarged, in the gap between the jet tab vectoring body 130 and flange 103, similar to the pressure adjustment parts 110 and 120 in the first embodiment and the second embodiment, and generate large flow path resistance due to a pressure loss in the portion in which a cross-sectional area is rapidly enlarged.

The pressure adjustment parts 110 and 120 in the third embodiment form a plurality of portions in which a cross-sectional area is rapidly enlarged, in the gap between the jet tab vectoring body 130 and flange 103. Further, the shape of the gap between the jet tab vectoring body 130 and flange 103 is a crank shape having a plurality of bent portions. For this reason, larger flow path resistance than the thrust vectoring device of the first or second embodiment in which a single pressure adjustment part 110 or 120 is provided is generated, and thus it becomes possible to more reliably interfere with arrival at the rotational drive shaft 140 of the high-temperature gas.

Further, the pressure adjustment part 120 in the thrust vectoring device 301 of the third embodiment configured in this manner prevents the high-temperature gas which infiltrates along the surface of the jet tab vectoring body 130 from directly reaching the rotational drive shaft 140. The pressure adjustment part 110 can have a width wider than the width (a dimension in an extending direction) of each of the jet tab vectoring body 130 and the pressure adjustment part 120, and therefore, the high-temperature gas going around the outside of the pressure adjustment part 120 is suppressed. For this reason, it is acceptable if the pressure adjustment part 120 is located at a portion closer to the nozzle 104 than the pressure adjustment part 110. However, the pressure adjustment part 110 can also be located at a portion closer to the nozzle 104 than the pressure adjustment part 120. Further, the pressure adjustment parts 110 and 120 are disposed at positions where the rotation locus of the pressure adjustment part 120 does not intersect with the pressure adjustment part 110 when the jet tab vectoring body 130 rotates.

### Fourth Embodiment

FIG. 4A is a schematic plan view showing a thrust vectoring device 401 of a fourth embodiment of the present invention, and FIG. 4B is a schematic sectional view taken along line D-D of the thrust vectoring device 401 shown in FIG. 4A.

In the thrust vectoring device 401 of the fourth embodiment, a plurality of pressure adjustment parts 110 and 111 are provided on the flange 103. In this embodiment, the thrust vectoring device 401 in which two pressure adjustment parts 110 and 111 are provided is described. However, three or more pressure adjustment parts may be provided. Further, a plurality of pressure adjustment parts may be provided on the jet tab vectoring body 130.

Further, a plurality of pressure adjustment parts may be provided on the jet tab vectoring body 130 and on the flange 103. In a case where the plurality of pressure adjustment parts are provided on the jet tab vectoring body 130 and on the flange 103, the pressure adjustment parts may be provided in any order along a straight line connecting the central axis S104 of the nozzle 104 and the central axis S140 of the rotational drive shaft 140. For example, the pressure adjustment parts provided on the jet tab vectoring body 130 and the pressure adjustment parts provided on the flange 103 can be alternately disposed along the straight line connecting the central axis S104 of the nozzle 104 and the central axis S140 of the rotational drive shaft 140. In a case of being configured in this manner, a gap which is formed between the jet tab vectoring body 130 and the flange 103 forms a crank-shaped flow path which is bent multiple times, and therefore, it is possible to further increase flow path resistance.

In a case where the plurality of pressure adjustment parts are provided on the jet tab vectoring body 130 and on the flange 103, the plurality of pressure adjustment parts are disposed at positions where the rotation locus of the pressure adjustment part provided on the jet tab vectoring body 130 does not intersect with the pressure adjustment part provided on the flange when the jet tab vectoring body 130 rotates.

Further, in a case where the plurality of pressure adjustment parts are provided on the jet tab vectoring body 130, on the flange 103, or on the both thereof, the heights of the pressure adjustment parts can be set such that gaps between the pressure adjustment parts and the jet tab vectoring body 130 or the flange 103 are different. For example, the heights of the pressure adjustment parts are set such that the gap between the pressure adjustment part closest to the nozzle 104 and the jet tab vectoring body 130 or the flange 103 is the largest, the gap between the pressure adjustment part farthest from the nozzle 104 and the jet tab vectoring body 130 or the flange 103 is the smallest, and the gaps between the pressure adjustment parts being intermediate therebetween and the jet tab vectoring body 130 or the flange 103 become smaller in order with increasing distance from the nozzle 104.

In a case where the plurality of pressure adjustment parts are provided, the pressure adjustment part disposed closest to the nozzle 104 is directly exposed to the high-temperature gas, and therefore, the pressure adjustment part reaches the highest temperature, and the temperatures of the pressure adjustment parts are lowered in order with increasing distance from the nozzle 104. For this reason, the pressure adjustment part disposed closest to the nozzle 104 thermally expands to the greatest extent, and the thermal expansion of the pressure adjustment parts is reduced in order with increasing distance from the nozzle 104. The gap between the pressure adjustment part and the jet tab vectoring body 130 or the flange 103 is made to be larger in advance as it goes to the pressure adjustment part close to the nozzle 104 and being large in thermal expansion, whereby all the pressure adjustment parts can form properly-sized gaps between themselves and the jet tab vectoring body 130 or the flange 103 at the time of thrust vectoring.

### Fifth Embodiment

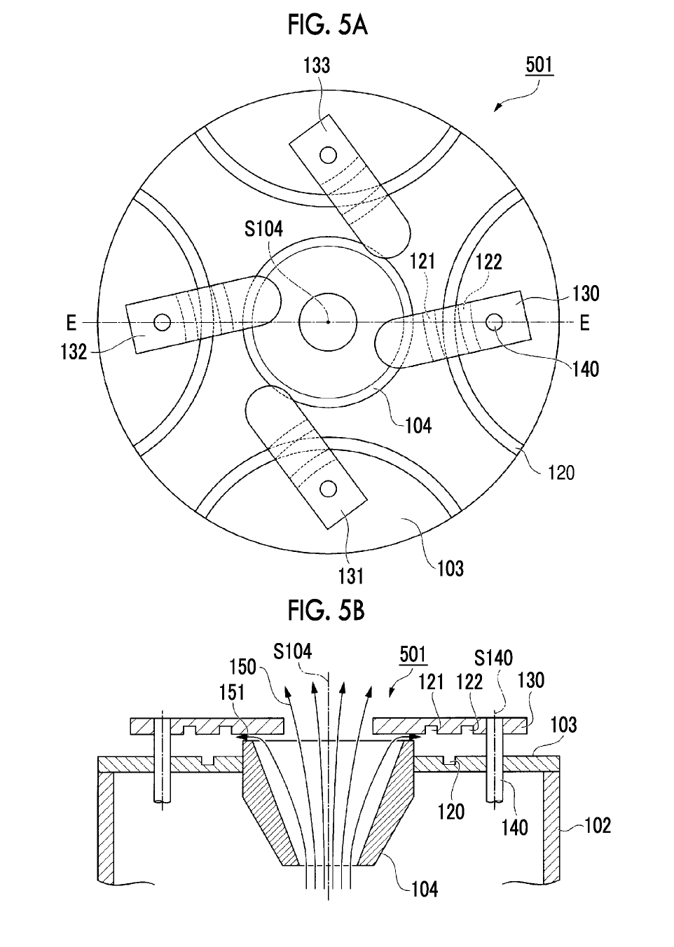

FIG. 5A is a schematic plan view showing a thrust vectoring device 501 of a fifth embodiment of the present invention, and FIG. 5B is a schematic sectional view taken along line E-E of the thrust vectoring device 501 shown in FIG. 5A.

Unlike the first to fourth embodiments, pressure adjustment parts 120 to 122 in the fifth embodiment are recess portions formed in at least one surface of the surfaces of the flange 103 and the jet tab vectoring body 130, which face each other. The pressure adjustment parts 120 to 122 may be formed in only one of the flange 103 and the jet tab vectoring body 130 and may be formed in both the flange 103 and the jet tab vectoring body 130. The recess-shaped pressure adjustment part forms a portion in which the cross-sectional area of the gap between the jet tab vectoring body 130 and the flange 103 is rapidly enlarged, and flow path resistance in the gap between the jet tab vectoring body 130 and the flange 103 increases due to a pressure loss in the portion, whereby the infiltrating high-temperature gas is prevented from reaching the rotational drive shaft 140.

The recess-shaped pressure adjustment part may be formed integrally with the flange 103 or the jet tab vectoring body 130, and the recess-shaped pressure adjustment part may be provided in a separate member mounted on the flange 103 or the jet tab vectoring body 130.

In a case of adopting the recess-shaped pressure adjustment part formed integrally with the flange 103 or the jet tab vectoring body 130, an additional member is not required, and therefore, this leads to a reduction in the weight of the thrust vectoring device 501. Further, as shown in FIG. 5B, in a case where the recess-shaped pressure adjustment parts 120 to 122 are formed in both the jet tab vectoring body 130 and the flange 103, unlike a protrusion-shaped pressure adjustment part, even if the jet tab vectoring body 130 is rotated, the pressure adjustment parts 121 and 122 formed on the jet tab vectoring body 130 side and the pressure adjustment part 120 formed on the flange 103 side do not collide with each other. Accordingly, it becomes possible to provide the pressure adjustment parts at arbitrary positions or in an arbitrary shape or number.

Further, in FIG. 5A, an example in which one pressure adjustment part is provided in the flange 103 and two pressure adjustment parts are provided in the jet tab vectoring body 130 is shown. However, the number of the pressure adjustment parts which are disposed may be any number. The more the number of pressure adjustment parts, the more the portion in which a cross-sectional area is rapidly enlarged is formed, whereby flow path resistance is more effectively increased. Further, the pressure adjustment part has a recess shape, and therefore, even if the jet tab vectoring body 130 is rotated, the pressure adjustment part formed on the jet tab vectoring body 130 side and the pressure adjustment part formed on the flange 103 side do not collide with each other, and thus the degree of freedom regarding the disposition of the pressure adjustment parts increases.

Further, in a case where a plurality of recess-shaped pressure adjustment parts 120 are formed, as described in the fourth embodiment, the gap between the pressure adjustment part closest to the nozzle 104 and the jet tab vectoring body 130 or the flange 103 can be made to be the largest and the gap between the pressure adjustment part farthest from the nozzle 104 and the jet tab vectoring body 130 or the flange 103 can be made to be the smallest. Further, the heights of the pressure adjustment parts can be set such that the gaps between the pressure adjustment parts provided in an intermediate portion between the nozzle 104 and the rotational drive shaft 140, and the jet tab vectoring body 130 or the flange 103 become smaller in order with increasing distance from the nozzle 104. In the thrust vectoring device having such pressure adjustment parts, the high-temperature gas which has flowed into the gap between the jet tab vectoring body 130 and the flange 103 receives flow path resistance in order at the portions formed by the pressure adjustment parts, in which a cross-sectional area is rapidly enlarged. For this reason, it is possible to more effectively increase flow path resistance which is formed between the jet tab vectoring body 130 and the flange 103.

Further, for example, the protrusion-shaped pressure adjustment part as shown in FIG. 1B or 2B and the recess-shaped pressure adjustment part as shown in FIG. 5B may be used in combination. In this case, for example, a configuration may be made in which the protrusion-shaped pressure adjustment part is provided on the jet tab vectoring body 130 and the recess-shaped pressure adjustment part is provided in the flange 103, and a reverse arrangement is also acceptable. Further, the protrusion-shaped pressure adjustment part and the recess-shaped pressure adjustment part may be provided in a mixed manner on the jet tab vectoring body 130 or the flange 103. In this case, a gap which is formed between the jet tab vectoring body 130 and the flange 103 forms a flow path having a complicated bent shape, and therefore, it is possible to further increase flow path resistance.

### Sixth Embodiment

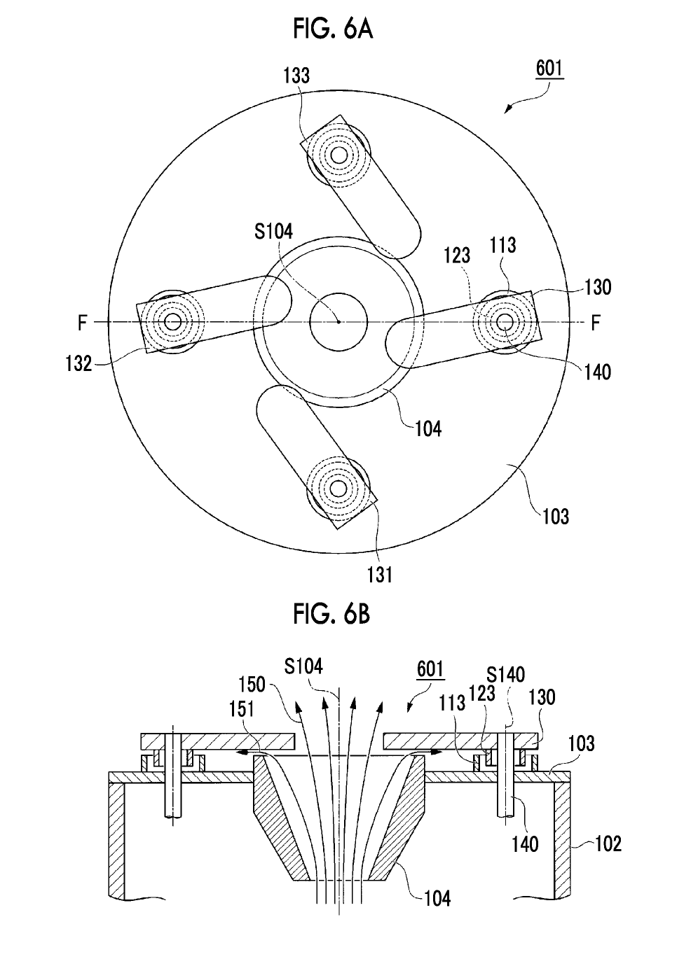

FIG. 6A is a schematic plan view showing a thrust vectoring device 601 of a sixth embodiment of the present invention, and FIG. 6B is a schematic sectional view taken along line F-F of the thrust vectoring device 601 shown in FIG. 6A.

Pressure adjustment parts 113 and 123 in the thrust vectoring device 601 of the sixth embodiment are characterized by being formed so as to surround the rotational drive shaft 140. The pressure adjustment parts configured in this manner more reliably prevent the high-temperature gas from reaching the rotational drive shaft 140. Further, it is acceptable if the pressure adjustment parts are disposed in the vicinity of the rotational drive shaft 140, and therefore, it becomes possible to reduce in the size of the pressure adjustment part, thereby reducing the weight of the thrust vectoring device 601. Further, as shown in FIG. 6A, if the pressure adjustment parts 113 and 123 are formed in concentric circle shapes centered on the central axis S140 of the rotational drive shaft 140, even if the jet tab vectoring body 130 is rotated, the pressure adjustment parts 113 and 123 do not come into contact with each other. For this reason, a design of the thrust vectoring device 601 becomes easy.

### Seventh Embodiment

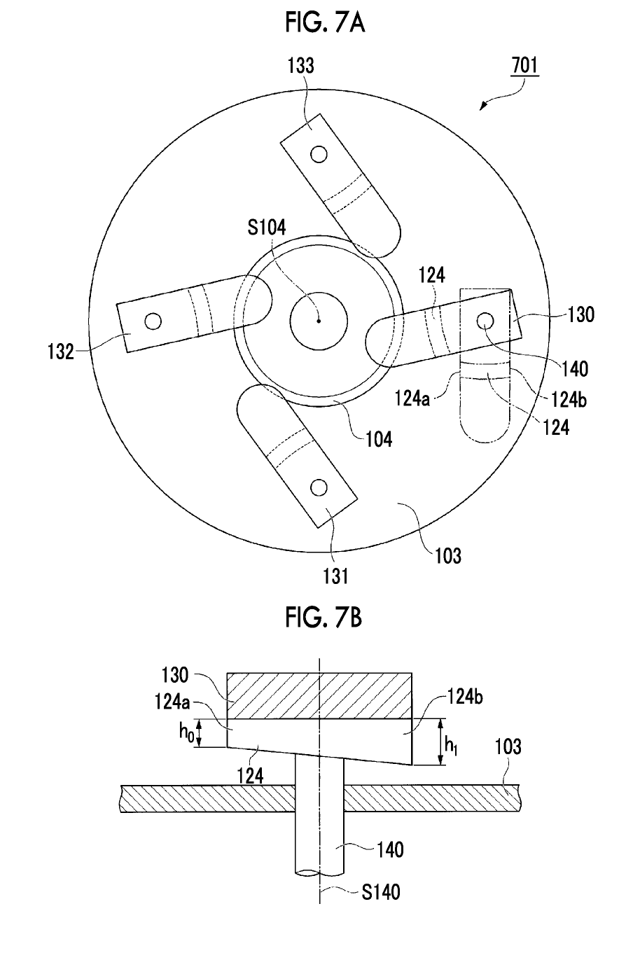

FIG. 7A is a schematic plan view showing a thrust vectoring device 701 of a seventh embodiment of the present invention, and FIG. 7B is a schematic sectional view showing the flange 103, the jet tab vectoring body 130, the rotational drive shaft 140, and a pressure adjustment part 124 when viewed from the central axis S104 of the nozzle 104 of FIG. 7A. In the thrust vectoring device 701, by rotating the jet tab vectoring body 130, it is possible to perform switching between a vectoring operation position where a tip portion of the jet tab vectoring body 130 has been moved to the upper side of the nozzle, and a non-vectoring operation position where the tip portion of the jet tab vectoring body 130 is not moved to the upper side of the nozzle.

The pressure adjustment part 124 has a protrusion shape protruding from the jet tab vectoring body 130. In the pressure adjustment part 124, the amount of protrusion from the surface of the jet tab vectoring body 130 in one end 124a of the pressure adjustment part 124 is h0, and in the other end 124b, the amount of protrusion is h1 which is larger than h0.

In this embodiment, the non-vectoring operation position indicates a state where the jet tab vectoring body 130 is disposed as shown by a dashed line of FIG. 7A. Then, at the non-vectoring operation position, one end 124a of the pressure adjustment part 124 becomes an end portion on the central axis S104 side of the nozzle 104 and the other end 124b of the pressure adjustment part 124 becomes an end portion on the side opposite to the central axis S104 side of the nozzle 104.

A case where the jet tab vectoring body 130 having the pressure adjustment part 124 is rotated about the central axis S140 of the rotational drive shaft 140, whereby the tip of the jet tab vectoring body 130 is moved to the upper side of the nozzle 104, is considered. The high-temperature gas which has collided with the jet tab vectoring body 130 is discharged radially from the nozzle 104. Therefore, as shown in FIG. 7A, in a case where the jet tab vectoring body 130 is set at the vectoring operation position, the high-temperature gas mainly collides with the portion, that is, one end 124a, which is on a line connecting the central axis S104 of the nozzle 104 and the central axis S140 of the rotational drive shaft 140, of the pressure adjustment part 124. For this reason, one end 124a of the pressure adjustment part 124 reaches a high temperature and the other end 124b is at a relatively low temperature. For this reason, the pressure adjustment part 124 non-uniformly thermally expands according to a temperature distribution. However, one end 124a of the pressure adjustment part 124 has the small amount of protrusion h0, as compared to the other end 124b, and therefore, even in a case where one end 124a reaches a higher temperature than the other end 124b, whereby thermal expansion at one end 124a becomes larger than at the other end 124b, one end 124a does not come into contact with the flange 103 and does not interfere with the rotation of the jet tab vectoring body 130.

In FIG. 7B, the pressure adjustment part 124 in which a lower end from one end 124a to the other end 124b of the pressure adjustment part 124 has a linear shape has been described. However, it is possible to adopt various shapes. For example, even in a case where the pressure adjustment part 124 non-uniformly thermally expands according to a temperature distribution of the pressure adjustment part 124 when it has been set at the vectoring operation position, it is also possible to design the shape of the lower end of the pressure adjustment part 124 in a zigzag shape or a curved line shape such that it is possible to make the gap between the lower end of the pressure adjustment part 124 and the flange 103 a predetermined gap.

Further, the pressure adjustment part 124 configured in this manner may be used along with, for example, the pressure adjustment part described in the first embodiment or the second embodiment having the constant amount of protrusion, in order to more effectively prevent arrival at the rotational drive shaft 140, of the high-temperature gas.

### Eighth Embodiment

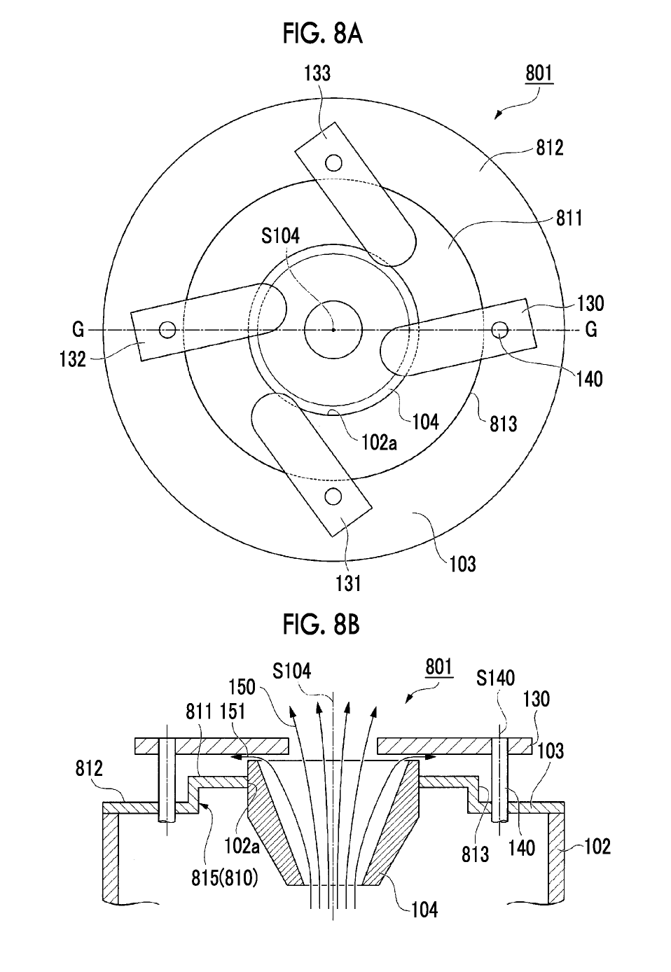

FIG. 8A is a schematic plan view showing a thrust vectoring device 801 of an eighth embodiment of the present invention, and FIG. 8B is a schematic sectional view taken along line G-G of the thrust vectoring device 801 shown in FIG. 8A. In the thrust vectoring device 801 of this embodiment, a pressure adjustment part 810 is different from those in the first embodiment to the seventh embodiment.

Here, in this embodiment, the one surface of the shroud 102 has a radially inner surface 811 in which an opening 102a of the shroud 102 in which the nozzle 104 is disposed is formed, and a radially outer surface 812 through which the rotational drive shaft 140 penetrates and which is provided at a position farther from the jet tab vectoring bodies 130 to 133 than the radially inner surface 811. Further, in the shroud 102, a stepped surface 813 connecting the radially inner surface 811 and the radially outer surface 822 and extending along an extending direction of the rotational drive shaft 140 is formed between the radially inner surface 811 and the radially outer surface 822.

Further, the pressure adjustment part 810 is a stepped portion 815 of the shroud 102, which forms the stepped surface 813.

In the thrust vectoring device 801 of this embodiment, when gas 151 jetted from the nozzle 104 passes between the one surface of the shroud 102 and the jet tab vectoring bodies 130 to 133, first, the gas 151 flows along the radially inner surface 811 on the side closer to the jet tab vectoring bodies 130 to 133. Here, the stepped portion 815 as the pressure adjustment part 810 is formed, whereby the cross-sectional area of a flow path of the gas 151 is rapidly enlarged at the position of the radially outer surface 812, and thus a pressure loss is generated. As a result, the flow path resistance of the gas 151 increases, whereby it is possible to prevent damage to the bearing or the drive unit for driving the rotational drive shaft 140.

Further, the gas 151 flowing along the radially inner surface 811 flows toward the outside in the radial direction of the nozzle 104 as it is. For this reason, the gas 151 flows at a position away from the radially outer surface 812. Therefore, the gas 151 flows through a position away from the bearing or the drive unit for driving the rotational drive shaft 140, and thus the gas can be prevented from coming into direct contact with the bearing or the drive unit. As a result, it is possible to prevent damage to the bearing or the drive unit.

Here, in this embodiment, a case where a single stepped surface 813 is formed has been described. However, a plurality of stepped surfaces 813 may be formed to be spaced apart from each other in the radial direction of the nozzle 104. That is, it is favorable if at the position where the rotational drive shaft 140 is provided, rather than the position where the nozzle 104 is provided, one surface of at least the shroud 102 is provided at a position away from the jet tab vectoring bodies 130 to 133 in a direction of the central axis S104 (S140).

### Ninth Embodiment

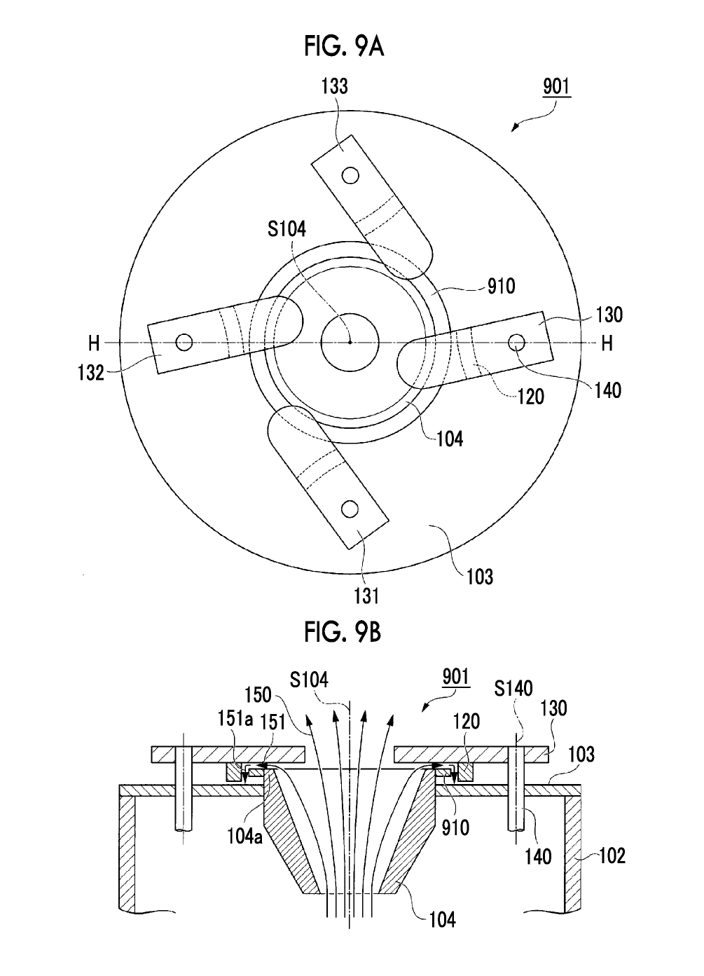

FIG. 9A is a schematic plan view showing a thrust vectoring device 901 of a ninth embodiment of the present invention, and FIG. 9B is a schematic sectional view taken along line H-H of the thrust vectoring device 901 shown in FIG. 9A. The thrust vectoring device 901 of this embodiment is different from those of the first embodiment to the eighth embodiment in that the thrust vectoring device 901 is further provided with a rib portion 910.

Here, in this embodiment, similar to the second embodiment, the pressure adjustment part 120 has a protrusion shape protruding in a vertical direction from the surface facing the one surface of the shroud 102 in each of the jet tab vectoring bodies 130 to 133. Further, the nozzle 104 has a projecting portion 104a projecting in a direction of the central axis S104 from the one surface of the shroud 102.

The rib portion 910 protrudes toward the pressure adjustment part 120 from the surface facing the outside in the radial direction in the projecting portion 104a of the nozzle 104. The rib portion 910 extends to a position close to the pressure adjustment part 120 such that the tip of the rib portion 910 faces the pressure adjustment part 120 in the radial direction with a gap therebetween. Further, the rib portion 910 has a ring shape centered on the central axis S104. In this embodiment, the rib portion 910 is provided so as to be flush with the upper surface (the surface facing the jet tab vectoring bodies 130 to 133 when the jet tab vectoring bodies 130 to 133 are disposed in the nozzle 104) of the nozzle 104.

The rib portion 910 is provided in this manner, whereby it is possible to further reduce the gap between the pressure adjustment part 120 and the nozzle 104 and it is possible to change a flow direction of the gas 151. Accordingly, a pressure loss increases, whereby it becomes difficult for the gas 151 to pass between the one surface of the shroud 102 and the jet tab vectoring bodies 130 to 133. Specifically, as shown in FIG. 9B, when the gas 151 flows between the rib portion 910 and the pressure adjustment part 120, a flow 151a of gas which heads for the one surface of the shroud 120 is formed. By this flow, it is possible to obtain a contraction flow effect on the gas 151 between the pressure adjustment part 120 and the shroud 102, and thus it is possible to increase a pressure loss of the gas 151. Therefore, it is possible to prevent damage to the bearing or the drive unit for driving the rotational drive shaft 140 due to the gas 151.

Here, in this embodiment, the rib portion 910 may be provided so as to protrude toward the projecting portion 104a of the nozzle 104 from the pressure adjustment part 120. Further, the rib portions 910 may be provided at both the pressure adjustment part 120 and the projecting portion 104a.

### Tenth Embodiment

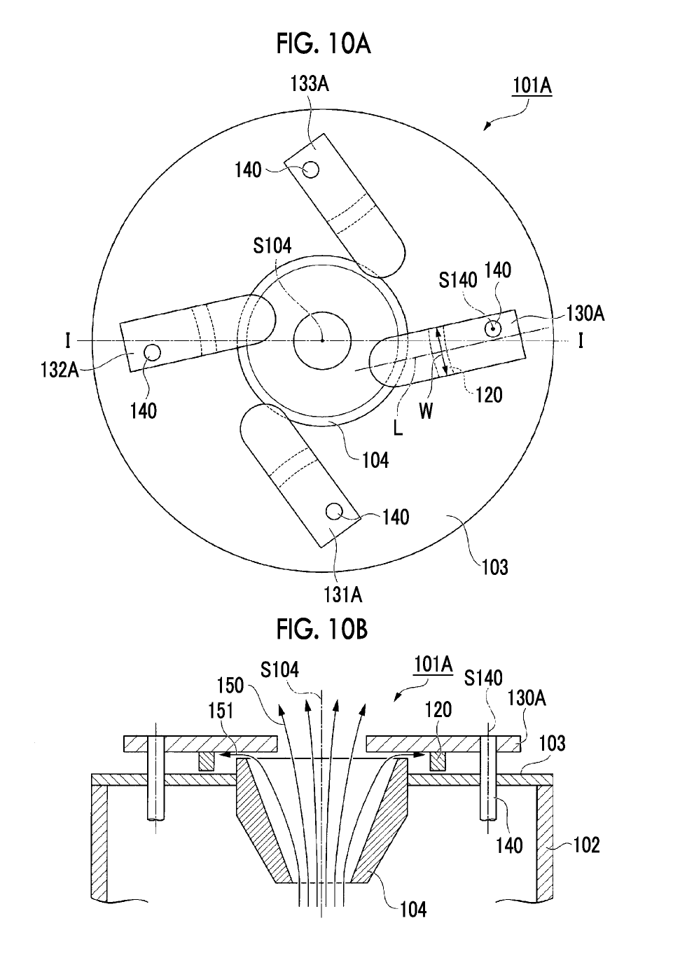

FIG. 10A is a schematic plan view showing a thrust vectoring device 101A of a tenth embodiment of the present invention, and FIG. 10B is a schematic sectional view taken along line I-I of the thrust vectoring device 101A shown in FIG. 10A. In the thrust vectoring device 101A of this embodiment, jet tab vectoring bodies 130A to 133A are different from those in the thrust vectoring device of each embodiment described above.

In each of the jet tab vectoring bodies 130A to 133A, the central axis S140 of the rotational drive shaft 140 does not intersect with a center line L in a direction of a width W along the circumferential direction of the nozzle 104 in each of the jet tab vectoring bodies 130A to 133A. That is, the rotational drive shaft 140 is provided such that the central axis S140 of the rotational drive shaft 140 is shifted in position with respect to the center line L of the nozzle 104.

According to the thrust vectoring device 101A of this embodiment, the gas 151 flowing along the surfaces facing the one surface of the shroud 102 in the jet tab vectoring bodies 130A to 133A flows along extending directions of the center lines L of the jet tab vectoring bodies 130A to 133A. Therefore, by providing the rotational drive shaft 140 such that a state where the central axis S140 of the rotational drive shaft 140 is shift in position from the center line L of each of the jet tab vectoring bodies 130A to 133A is created, it is possible to prevent the gas 151 from flowing toward the rotational drive shaft 140. As a result, it is possible to prevent damage to the bearing or the drive unit for driving the rotational drive shaft 140 due to the gas 151.

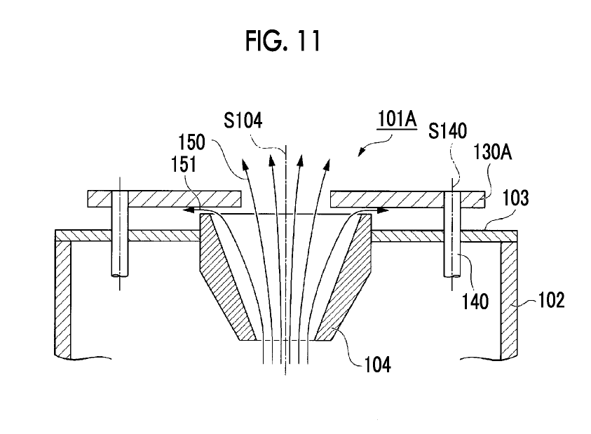

Here, as shown in FIG. 11, in this embodiment, the pressure adjustment part 110 may not be necessarily provided.

### Eleventh Embodiment

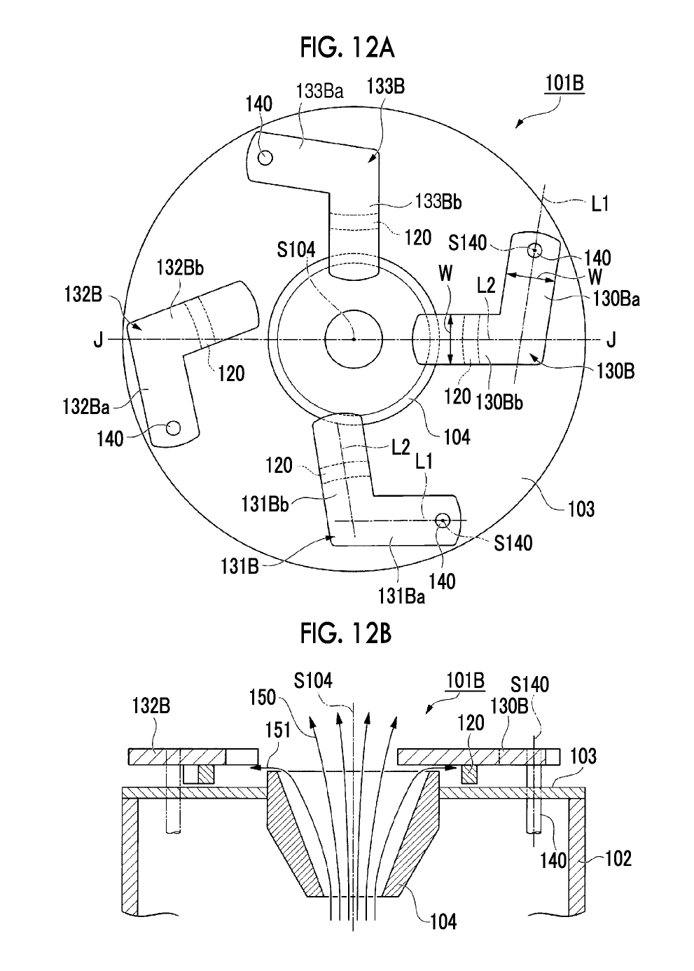

FIG. 12A is a schematic plan view showing a thrust vectoring device 101B of an eleventh embodiment of the present invention, and FIG. 12B is a schematic sectional view taken along line J-J of the thrust vectoring device 101B shown in FIG. 12A. In the thrust vectoring device 101B of this embodiment, jet tab vectoring bodies 130B to 133B are different from those in the thrust vectoring device of each embodiment described above.

The jet tab vectoring bodies 130B to 133B respectively have base end portions 130Ba to 133Ba, in each of which the rotational drive shaft 140 is provided, and tip portions 130Bb to 133Bb which are respectively bent from the base end portions 130Ba to 133Ba and extend in directions away from the rotational drive shafts 140.

Each of the base end portions 130Ba to 133Ba is disposed such that a center line L1 in the direction of the width W extends along the circumferential direction of the nozzle 104 in a state where each of the jet tab vectoring bodies 130B to 133B is at the non-vectoring operation position (refer to the jet tab vectoring body 132B of FIG. 12A).

Each of the tip portions 130Bb to 133Bb is formed integrally with each of the base end portions 130Ba to 133Ba and disposed such that a center line L2 in the direction of the width W extends toward the nozzle 104 in a state where each of the jet tab vectoring bodies 130B to 133B is at the non-vectoring operation position. As a result, each of the jet tab vectoring bodies 130B to 133B has an L-shape when viewed from the direction of the central axis S104.

The gas 151 which flows along a surface facing the one surface of the shroud 102 flows along extending directions of the tip portions 130Bb to 133Bb. Here, each of the tip portions 130Bb to 133Bb is provided to be bent with respect to each of the base end portions 130Ba to 133Ba, and therefore, each of the base end portions 130Ba to 133Ba extends in a direction different from the extending direction of each of the tip portions 130Bb to 133Bb. Therefore, the gas 151 can be prevented from flowing toward the rotational drive shaft 140 provided at each of the base end portions 130Ba to 133Ba. As a result, it is possible to prevent damage to the bearing or the drive unit for driving the rotational drive shaft 140 due to the gas 151.

Here, in this embodiment, each of the tip portions 130Bb to 133Bb is provided to be bent with respect to each of the base end portions 130Ba to 133Ba. However, for example, each of the tip portions 130Bb to 133Bb may be provided so as to be curved with respect to each of the base end portions 130Ba to 133Ba. That is, it is acceptable if at least the center line L1 of each of the base end portions 130Ba to 133Ba and the center line L2 of each of the tip portions 130Bb to 133Bb extend in different directions. In other words, it is acceptable if the jet tab vectoring body is disposed at a position where the central axis S140 of the rotational drive shaft 140 and an extended line of the center line L2 in each of the tip portions 130Bb to 133Bb do not intersect one another in a state where each of the jet tab vectoring bodies 130B to 133B is disposed inside of the nozzle 104 (the vectoring operation position).

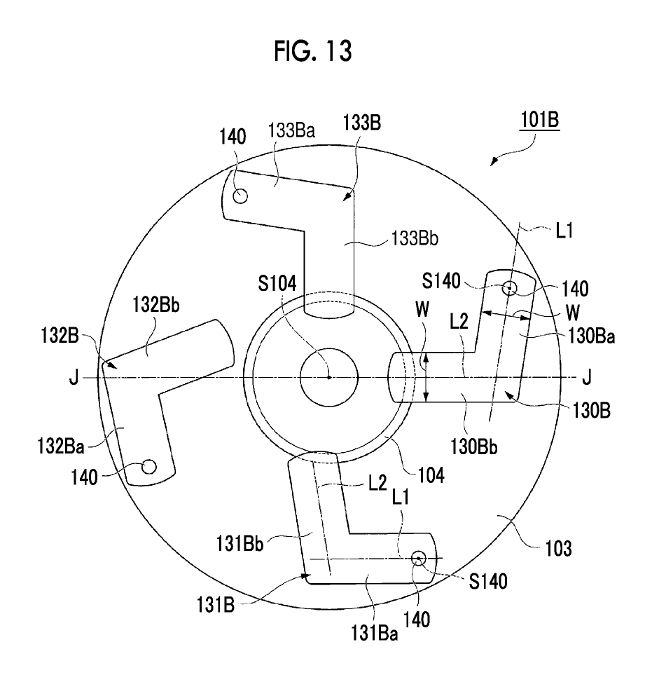

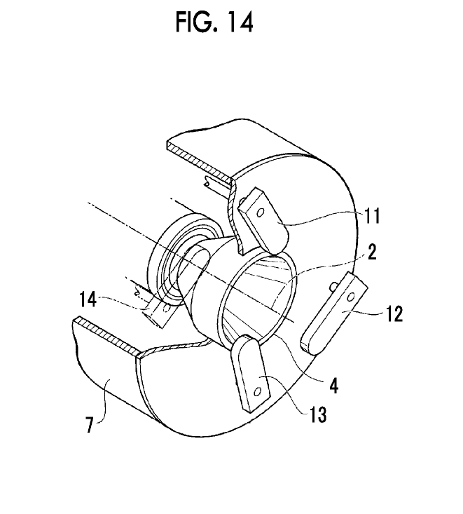

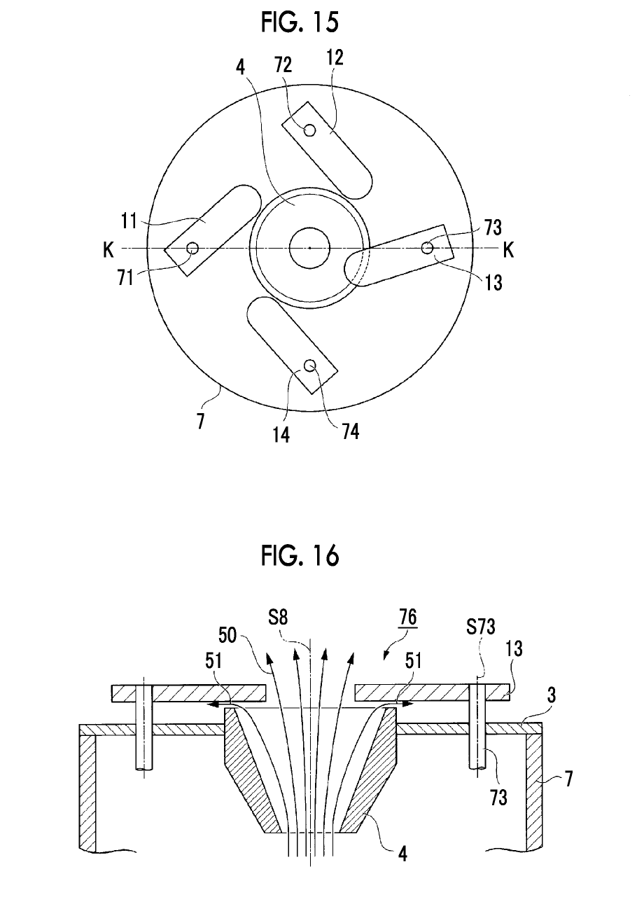

Here, as shown in FIG. 13, in this embodiment, the pressure adjustment part 110 may not be necessarily provided.

The embodiments of the present invention have been described above in detail with reference to the drawings. However, the respective configurations in the respective embodiments and combinations thereof or the like is an example, and addition, omission, substitution, and other changes of a configuration can be made within a scope which does not depart from the gist of the present invention. Further, the present invention is not limited by the embodiments, but is limited only by the scope of the appended claims. Therefore, for example, the respective embodiments described above may be combined.

### INDUSTRIAL APPLICABILITY

According to the thrust vectoring device described above, heating of the rotational drive shaft due to high-temperature gas which has infiltrated into the gap between the one surface of the shroud and a jet direction vectoring member reaching the rotational drive shaft is prevented, and damage to the bearing or the drive unit for driving the rotational drive shaft can be prevented.

### REFERENCE SIGNS LIST

76, 101, 201, 301, 401, 501, 601, 701, 801, 901,

101A, 101B: thrust vectoring device

102: shroud

103: flange

104: nozzle

S104: central axis of nozzle

110 to 113, 120 to 124, 810: pressure adjustment part

130 to 133, 130A to 133A, 130B to 133B: jet tab vectoring body

140: rotational drive shaft

S140: central axis of rotational drive shaft

50, 51, 150, 151, 151a: flow of high-temperature gas

811: radially inner surface

812: radially outer surface

813: stepped surface

815: stepped portion

910: rib portion

130Ba to 133Ba: base end portion

130Bb to 133Bb: tip portion

1. A thrust vectoring device comprising:
a shroud having an opening;
a nozzle which is disposed inside of the shroud and jets gas through the opening of the shroud;
a rotational drive shaft disposed parallel to a central axis of the shroud to penetrate one surface of the shroud; and
a jet direction vectoring member which is provided at a portion of the rotational drive shaft which is located outside the shroud, and faces the one surface of the shroud,
wherein a pressure adjustment part disposed to face a flow of gas which heads for the rotational drive shaft is provided on at least one surface of the one surface of the shroud and a surface facing the one surface of the shroud, of the jet direction vectoring member.

2. The thrust vectoring device according to claim 1, wherein each of the one surface of the shroud and the jet direction vectoring member has a flat plate shape, and the one surface of the shroud and a facing surface of the jet direction vectoring member are parallel to each other.

3. The thrust vectoring device according to claim 1, wherein the pressure adjustment part is a protrusion portion which protrudes in a vertical direction from at least one surface of the one surface of the shroud and a facing surface of the jet direction vectoring member.

4. The thrust vectoring device according to claim 1, wherein the pressure adjustment part is a recess portion provided in at least one surface of the one surface of the shroud and a facing surface of the jet direction vectoring member.

5. The thrust vectoring device according to claim 1, wherein the pressure adjustment parts are provided on the one surface of the shroud and a surface of the jet direction vectoring member, and
at least one of the pressure adjustment parts provided on the surface of the jet direction vectoring member is disposed closer to the nozzle than all the pressure adjustment parts provided on the one surface of the shroud.

6. The thrust vectoring device according to claim 1, wherein gaps having different distances, provided between the one surface of the shroud and the jet direction vectoring member, become smaller in order as it goes toward the outside from a central axis of the nozzle.

7. The thrust vectoring device according to claim 1, wherein the pressure adjustment part is provided so as to surround the rotational drive shaft.

8. The thrust vectoring device according to claim 1, wherein the pressure adjustment part is a protrusion portion which protrudes from a surface of the jet direction vectoring member, and
when the jet direction vectoring member in a non-vectoring operation state is disposed orthogonal to a plane which includes a central axis of the nozzle and a rotation axis of the rotational drive shaft, a length from the surface of the jet direction vectoring member in a surface facing the central axis side of the nozzle, of the protrusion portion, is shorter than a length from the surface of the jet direction vectoring member in a surface facing the side opposite to the surface facing the central axis side of the protrusion portion.

9. The thrust vectoring device according to claim 1, wherein the one surface of the shroud has
a radially inner surface in which the opening is formed, and
a radially outer surface through which the rotational drive shaft penetrates and which is provided at a position farther away from the jet direction vectoring member than the radially inner surface, and
the pressure adjustment part is a stepped portion in the shroud, which connects the radially inner surface and the radially outer surface and forms a stepped surface along an extending direction of the rotational drive shaft between the radially inner surface and the radially outer surface.

10. The thrust vectoring device according to claim 1, wherein the pressure adjustment part is a protrusion portion which protrudes in a vertical direction from a facing surface of the jet direction vectoring member,
the nozzle has a projecting portion which projects from the shroud, and
the thrust vectoring device further comprises a rib portion which protrudes from at least one of a surface facing the outside in a radial direction of the nozzle in the projecting portion and the protrusion portion toward the other.

11. The thrust vectoring device according to claim 1, wherein the rotational drive shaft is disposed at a position where a central axis of the rotational drive shaft and a center line in a width direction along a circumferential direction of the nozzle in the jet direction vectoring member do not intersect one another in a state where the jet direction vectoring member is disposed inside of the nozzle.

12. The thrust vectoring device according to claim 11, wherein the jet direction vectoring member has
a base end portion in which the rotational drive shaft is provided, and
a tip portion which extends to be bent or curved from the base end portion.

13. A thrust vectoring device comprising:
a shroud having an opening;
a nozzle which is disposed inside of the shroud and jets gas through the opening of the shroud;
a rotational drive shaft disposed parallel to a central axis of the shroud to penetrate one surface of the shroud; and
a jet direction vectoring member which is provided at a portion of the rotational drive shaft which is located outside the shroud, and faces the one surface of the shroud,
wherein the rotational drive shaft is disposed at a position where a central axis of the rotational drive shaft and a center line in a width direction along a circumferential direction of the nozzle in the jet direction vectoring member do not intersect one another in a state where the jet direction vectoring member is disposed inside of the nozzle.
